(19) United States
(12) Patent Application Publication
(10) Pub. No.: US 2020/0296641 A1
(43) Pub. Date: Sep. 17, 2020

(54) APPARATUS AND METHOD FOR HANDOVER BASED ON LEARNING USING EMPIRICAL DATA

(71) Applicant: ELECTRONICS AND TELECOMMUNICATIONS RESEARCH INSTITUTE, Daejeon (KR)

(72) Inventors: Yoo Seung SONG, Daejeon (KR); Do Wook KANG, Daejeon (KR); Shin Kyung LEE, Daejeon (KR); Jeong Woo LEE, Daejeon (KR)

(21) Appl. No.: 16/810,601

(22) Filed: Mar. 5, 2020

(30) Foreign Application Priority Data
Mar. 15, 2019 (KR) 10-2019-0030151

(51) Int. Cl. H04W 36/00; H04W 36/08

(52) U.S. Cl. CPC H04W 36/00837; H04W 36/0085; H04W 36/08

(57) ABSTRACT

Provided is an apparatus and a method for hand-over that allow a seamless wireless network service based on learning using empirical data, the apparatus including a memory in which a learning-based handover program is stored and a processor configured to execute the program, in which the processor receives communication related state information to select an access node according to a policy and evaluates a level of satisfaction on the selected access node.

### CROSS-REFERENCE TO RELATED APPLICATION

This application claims priority to and the benefit of Korean Patent Application No. 10-2019-0030151, filed on Mar. 15, 2019, the disclosure of which is incorporated herein by reference in its entirety.

### BACKGROUND

### 1. Field of the Invention

The present invention relates to an apparatus and a method for a handover based on learning that allow a seamless wireless network service to be provided using empirical data.

### 2. Discussion of Related Art

Handover decision techniques or algorithms according to the related art measure a limited communication environment in a specific communication condition and mathematically interpret the measured communication environment.

The related art, due to being based on mathematical analysis, considers a number of assumptions on a communication condition, and a numerical analysis accurately modeling a real environment is substantially impossible.

In addition, communication devices are each placed in different communication conditions, yet an algorithm analyzed under a specific condition is applied to all the communication devices in the same way.

### SUMMARY OF THE INVENTION

The present invention provides an apparatus and method for a handover between access nodes that is required to receive a high-quality communication service through a seamless wireless network access even in a state in which a pedestrian or vehicle carrying a wireless communication device continuously move or a wireless channel environment changes.

The technical objectives of the present invention are not limited to the above, and other objectives may become apparent to those of ordinary skill in the art based on the following description.

According to one aspect of the present invention, there is provided an apparatus for a handover based on learning using empirical data, the apparatus including a memory in which a learning-based handover program is stored and a processor configured to execute the program, wherein the processor receives communication related state information to select an access node according to a policy and evaluates a level of satisfaction on the selected access node.

According to another aspect of the present invention, there is provided a method for a handover based on learning using empirical data, the method including receiving communication related state information, determining an access node according to a policy using the communication related state information, and evaluating a level of satisfaction on the determined access node.

### BRIEF DESCRIPTION OF THE DRAWINGS

FIG. 1 is a block diagram illustrating an apparatus for a handover based on learning using empirical data according to an embodiment of the present invention.

FIGS. 2 and 3 are block diagrams illustrating a system for a handover based on learning using empirical data according to an embodiment of the present invention.

FIG. 4 illustrates a data processing procedure using a deep Q-network (DQN) according to an embodiment of the present invention.

FIG. 5 is a flowchart showing a method for a handover based on learning using empirical data according to an embodiment of the present invention.

### DETAILED DESCRIPTION OF EXEMPLARY EMBODIMENTS

Hereinafter, the above and other objectives, advantages and features of the present invention and manners of achieving them will become readily apparent with reference to descriptions of the following detailed embodiments when considered in conjunction with the accompanying drawings

However, the present invention is not limited to such embodiments and may be embodied in various forms. The embodiments to be described below are provided only to assist those skilled in the art in fully understanding the objectives, constitutions, and the effects of the invention, and the scope of the present invention is defined only by the appended claims.

Meanwhile, terms used herein are used to aid in the explanation and understanding of the embodiments and are not intended to limit the scope and spirit of the present invention. It should be understood that the singular forms “a,” “an,” and “the” also include the plural forms unless the context clearly dictates otherwise. The terms “comprises,” “comprising,” “includes,” and/or “including,” when used herein, specify the presence of stated features, integers, steps, operations, elements, components and/or groups thereof and do not preclude the presence or addition of one or more other features, integers, steps, operations, elements, components, and/or groups thereof.

Before describing embodiments of the present invention, a background for proposing the present invention will be described first for the sake of understanding of those skilled in the art.

Pedestrians may find tens of wireless LAN access points (APs) in a large shopping center or a downtown area where stores are concentrated, and while walking, handovers between APs consecutively occurs.

When a pedestrian carrying a smartphone rides in a car or a connected car equipped with an on-board unit (OBU) that communicates with a road side unit (RSU) travels in a downtown area or on a highway, the handover phenomenon frequently occurs.

The conventional handover technique mostly determines an access node (AN) on which the next handover is to be performed by calculating a distance to a base station (BS) or APs existing around a terminal and a magnitude of a signal transmitted from the BS or APs.

The AN is a wireless network device connected to an edge of an infrastructure and collectively referred to as an AP or an evolved node B (eNodeB).

In response to recognizing the existence of an AN providing a reception power stronger than that of the currently connected wireless link, a handover procedure is performed.

In areas where two or more ANs are found, it is highly difficult to determine the dominance of the received signal strength due to noise or interference In order to remove such a limitation, a noise canceling filter or various decision metrics are used to determine the AN on which a handover is to be performed.

Handover decision techniques or algorithms according to the related art measure a limited communication environment in a specific communication condition and mathematically interpret the measured communication environment.

The related art, due to being based on mathematical analysis, considers a number of assumptions on a communication condition, and a numerical analysis accurately modeling a real environment is substantially impossible.

In addition, communication devices are each placed in different communication conditions, yet an algorithm analyzed under a specific condition is applied to all the communication devices in the same way.

The present invention has been proposed to remove the above-described limitations and propose an apparatus and method for a handover in consideration of an actual environment, and according to embodiments of the present invention, a seamless wireless network access and a high quality communication service may be provided through a handover between ANs even when a pedestrian or vehicles carrying a wireless communication device continuously move or a wireless channel environment changes.

The embodiments of the present invention propose an apparatus and method for a handover based on learning using empirical data capable of finding an optimum handover method by learning an experience of a user, wherein all determinations made on the basis of the states of various communication environments of users are learned so that each user can find an optimum handover suitable for the state of each user.

According to the embodiments of the present invention, it is not that an environment is numerically modeled and assumed, but rather, learning is performed to reach an optimum value on the basis of actual experience so that a determination value through the learning converges to the optimum value over time.

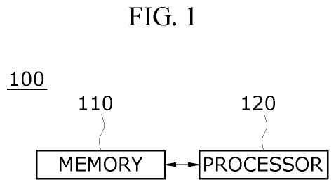

FIG. 1 is a block diagram illustrating an apparatus for a handover based on learning using empirical data according to an embodiment of the present invention.

An apparatus 100 for a handover based on learning using empirical data includes a memory 110 in which a learning-based handover program is stored and a processor 120 configured to execute the program, and the processor 120 receives communication related state information to select an AN according to a policy and evaluates the level of satisfaction on the selected AN.

The processor 120 receives the communication related state information including communication environment state information of a user and state information of data to be transmitted and receives the communication environment state information including a received signal strength received from a neighboring AN, a distance to the AN, movement information of the user, a packet reception rate, and a packet delay time.

The processor 120 evaluates the level of satisfaction using state information of the user that is updated according to the selection of the AN, and in this case, considers network traffic, a handover frequency, and a packet forwarding delay time.

The processor 120 performs setting or changing on a default value of a weighting factor when evaluating the level of satisfaction and performs evaluation on the level of satisfaction using the weighting factor that is adjusted in consideration of a preference tendency of the user on an application.

For example, the processor 120 may evaluate the level of satisfaction by first considering a user tendency of preferring a lower handover frequency over other factors.

The processor 120 reflects handover policy update information that is a result of learning associated with the evaluation on the level of satisfaction in the selection of the AN.

In this case, the processor 120 may collect data associated with evaluating the level of satisfaction, store the collected data, and update the policy and reflect the policy update information in the selection of the AN, or the processor 120 may receive update information that is a result of updating a policy performed by a processing apparatus server 200 separated from the processor 120 and reflect the update information in the selection of the AN.

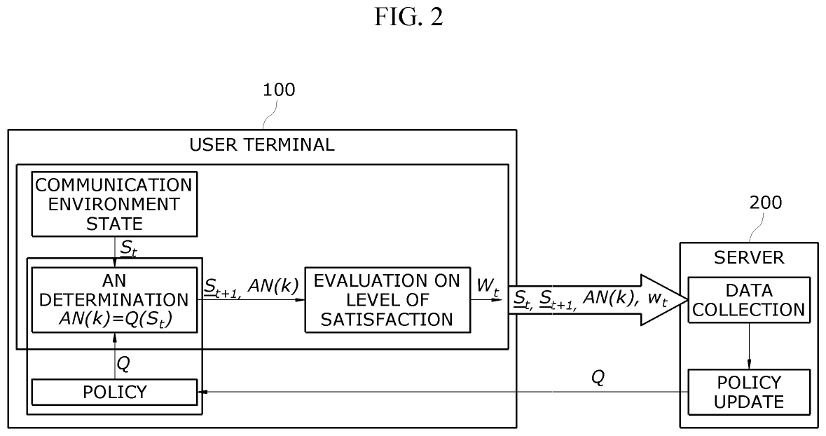

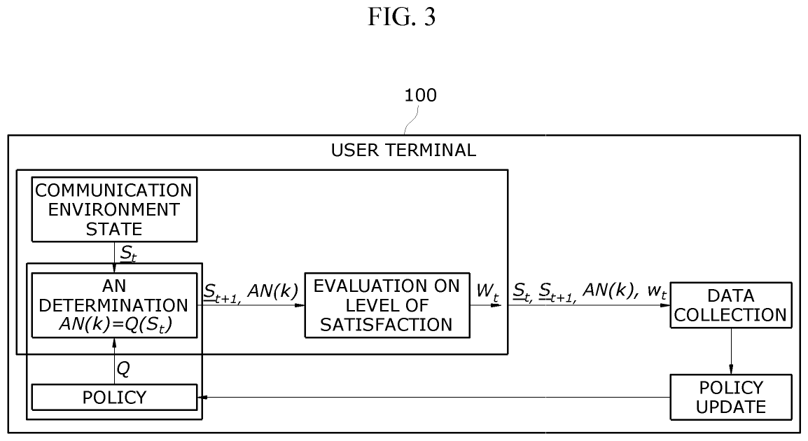

FIGS. 2 and 3 are block diagrams illustrating a system for a handover based on learning using empirical data according to an embodiment of the present invention.

FIG. 2 illustrates an embodiment of a separate-type data set collection and processing in which data collection, data storage, and policy update are performed by the processing apparatus server 200.

Although only one user terminal 100 is illustrated in FIG. 2, the processing apparatus server 200 may receive information associated with evaluating the level of satisfaction from a plurality of user terminals (n terminals) via a wireless transmission and collect and store data related to the information and update the policy, thereby enabling crowdsourcing.

FIG. 3 illustrates an embodiment of an integrated-type data set collection and processing in which data collection, data storage, and policy update are performed by the user terminal 100.

According to the embodiment of the present invention, the user terminal 100 first identifies a state of the user terminal 100, and information related to the identification is used as an input value for determining the policy.

The user state information includes both profile information of the user and state information of a surrounding environment that the user experiences, and a policy determination function calculation and an output determination value that are based on the user state information are applied to an actual field.

In this case, the user terminal 100 employing the determination value measures and evaluates the degree to which the user terminal 100 is satisfied with the determination in a given environment, and the result of the evaluation is provided as feedback for updating a coefficient of the policy function such that an improved policy is established.

According to the embodiment of the present invention, the policy determination concept is provided such that the policy is determined in an improvement direction when performing a handover in a wireless communication environment.

The user terminal 100 initially transmits the state of a communication environment to which the user terminal 100 belongs, the state of data to be currently transmitted, and other information as an input value for determining an AN.

When the AN is determined according to the current policy, the user terminal 100 uses the selected AN and evaluates the level of satisfaction experienced.

The communication environment state information, the AN determination value, and the satisfaction information may be transmitted to the processing apparatus server 200 as shown in FIG. 2, or data collection, data storage, and policy update may be performed in the user terminal 100 as shown in FIG. 3.

In this case, the data may be collected from one user, but when a large amount of data is collected from a plurality of user terminals in updating the policy, the optimal policy determination may be reached more rapidly and accurately.

The communication environment state information of the user includes received signal strengths (p=[p1, p2, . . . ]) received from neighboring ANs, distances to the neighboring ANs (d=[d1, d2, . . . ]), a direction and speed of movement of the user, a packet reception rate with a currently connected AN, a packet delay time, and the like.

In this case, with respect to the current time t, state information sₜ is defined as a vector including the above described pieces of information as components.

In addition, the size of a transmission packet of the user terminal, a waiting time of a packet currently existing in a buffer, and other values may be additionally used.

Upon receiving the state information sₜ of the user, a decision function Q( ) determines an AN AN(k), which will access an infrastructure, as an output value.

Here, k denotes an index of the AN, and the state information of the user is newly updated to sₜ₊₁ according to the determined AN (k).

The user terminal 100 evaluates a level of satisfaction wₜ on the determination of the newly updated AN(k), and the satisfaction calculation is performed through Equation 1 below.

wₜf·wₜ₋₁+(1−f){λ₁hₜ₊₁λ₂·rₜ₊₁} [Equation 1]

f is a forgetting factor, λ is a weighting factor, h is network traffic, and r is an AN switching rate (a handover frequency).

When the delay time nₜ₊₁ of the packet remaining in the user buffer is also reflected in the level of satisfaction, λ₃nₜ₊₁ is added to the above-described Equation 1.

The state information sₜ of the user, the AN determination value AN(k), the state information sₜ₊₁ of the user updated after the policy determination, and the level of satisfaction wₜ on the determined policy are transmitted to the apparatus for learning.

In order to improve the speed and accuracy of the learning, a plurality of users participate in the learning and transmit corresponding information to the learning processing apparatus, and a new handover policy Q, which is a result of the learning, is transmitted to each user terminal.

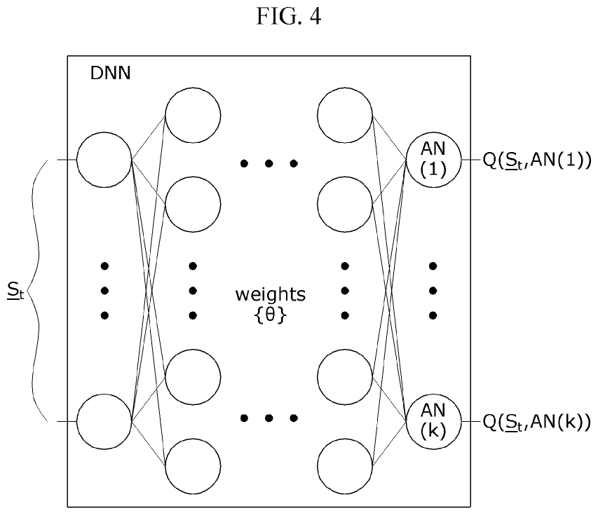

FIG. 4 illustrates a data processing procedure using a deep Q-network (DQN) according to an embodiment of the present invention.

As a technique used in the data processing apparatus for learning, a deep reinforcement learning algorithm, such as the DQN, or various learning algorithms used for other types of learning may be used.

In this case, the update is performed in a direction of minimizing a loss in Equation 2 below, which leads to a weight convergence.

L(θ)=E{(Wₜ+γmax Q(Sₜ,AN,θ)−Q(Sₜ₊₁,AN,θ))²} [Equation 2]

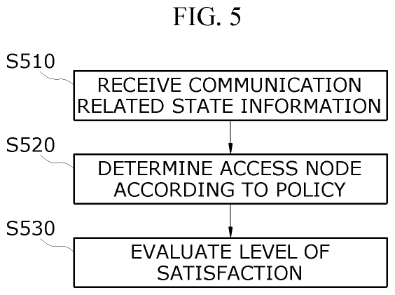

FIG. 5 is a flowchart showing a method for a handover based on learning using empirical data according to an embodiment of the present invention.

The method for a handover based on learning using empirical data according to the embodiment of the present invention includes receiving communication related state information (S510), determining an AN according to a policy using the communication related state information (S520), and evaluating the level of satisfaction on the selected AN (S530).

In operation S510, the communication environment state information including a received signal strength received from a neighboring AN, a distance to the neighboring AN, movement information of the user, a packet reception rate, and a packet delay time is received.

In operation S530, the level of satisfaction on a network service is evaluated by updating state information of a user according to the determination of the AN, and in this case, the level of satisfaction is evaluated in consideration of network traffic, a handover frequency, and a packet forwarding delay time.

In operation S530, setting or changing is performed on each weighting factor of the network traffic, the handover frequency, and the packet forwarding delay time to evaluate the level of satisfaction, and adjustment is performed on the weighting factor in consideration of a preference tendency of the user on a characteristic of an application.

In operation S520, the determining of the AN is performed using handover policy update information that is a result of learning information about the evaluation on the level of satisfaction received from a plurality of user terminals.

Meanwhile, the method for handover based on learning using empirical data according to the embodiment of the present invention may be implemented in a computer system or may be recorded on a recording medium. The computer system may include at least one processor, a memory, a user input device, a data communication bus, a user output device, and a storage. The above described components perform data communication through the data communication bus.

The computer system may further include a network interface coupled to a network. The processor may be a central processing unit (CPU) or a semiconductor device for processing instructions stored in the memory and/or storage.

The memory and the storage may include various forms of volatile or nonvolatile media. For example, the memory may include a read only memory (ROM) or a random-access memory (RAM).

The method for handover based on learning using empirical data according to the embodiment of the present invention may be implemented in a form executable by a computer. When the method for handover based on learning using empirical data according to the embodiment of the present invention is performed by the computer, instructions readable by the computer may perform the method for handover based on learning using empirical data according to the embodiment of the present invention

Meanwhile, the method for handover based on learning using empirical data according to the embodiment of the present invention may be embodied as computer readable codes on a computer-readable recording medium. The computer-readable recording medium is any recording medium that can store data that can be read thereafter by a computer system. Examples of the computer-readable recording medium include a ROM, a RAM, a magnetic tape, a magnetic disk, a flash memory, an optical data storage, and the like. In addition, the computer-readable recording medium may be distributed over network-connected computer systems so that computer readable codes may be stored and executed in a distributed manner.

As is apparent from the above, the apparatus and method for a handover based on learning using empirical data can select an optimum AN for achieving a user setting level of satisfaction by specifically considering a communication environment of a user (traffic, interference, and the like) and a state of a terminal (a packet size, a delay time, a movement speed, a movement direction, and the like).

The effects of the present invention are not limited to those mentioned above, and other effects not mentioned above will be clearly understood by those skilled in the art from the detailed description.

Although the present invention has been described with reference to the embodiments, a person of ordinary skill in the art should appreciate that various modifications, equivalents, and other embodiments are possible without departing from the scope and sprit of the present invention. Therefore, the embodiments disclosed above should be construed as being illustrative rather than limiting the present invention. The scope of the present invention is not defined by the above embodiments but by the appended claims of the present invention, and the present invention is to cover all modifications, equivalents, and alternatives falling within the spirit and scope of the present invention.

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium.

A processor and a memory may be supplemented by, or integrated into, a special purpose logic circuit. The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

What is claimed is:

1. An apparatus for a handover based on learning using empirical data, the apparatus comprising:
a memory in which a learning-based handover program is stored; and
a processor configured to execute the program,
wherein the processor receives communication related state information to select an access node according to a policy and evaluates a level of satisfaction on the selected access node.

2. The apparatus of claim 1, wherein the processor receives the communication related state information including communication environment state information of a user and state information of data to be transmitted.

3. The apparatus of claim 2, wherein the processor receives the communication environment state information including a received signal strength received from a neighboring access node, a distance to the neighboring access node, movement information of the user, a packet reception rate, and a packet delay time.

4. The apparatus of claim 1, wherein the processor evaluates the level of satisfaction using state information of a user that is updated according to the selection of the access node.

5. The apparatus of claim 1, wherein the processor evaluates the level of satisfaction in consideration of network traffic, a handover frequency, and a packet forwarding delay time.

6. The apparatus of claim 5, wherein the processor performs setting or changing on a default value of a weighting factor when evaluating the level of satisfaction.

7. The apparatus of claim 5, wherein the processor evaluates the level of satisfaction using a weighting factor that is adjusted in consideration of a preference tendency of the user on an application.

8. The apparatus of claim 1, wherein the processor reflects handover policy update information that is a result from learning associated with the evaluation on the level of satisfaction in the selection of the access node.

9. A method for a handover based on learning using empirical data, the method comprising the steps of:
(a) receiving communication related state information:
(b) determining an access node according to a policy using the communication related state information; and
(c) evaluating a level of satisfaction on the determined access node.

10. The method of claim 9, where step (a) includes receiving communication environment state information including a received signal strength received from a neighboring access node, a distance to the neighboring access node, movement information of a user, a packet reception rate, and a packet delay time.

11. The method of claim 9, wherein step (c) includes updating state information of a user according to selection of the access node to evaluate a level of satisfaction on a network service.

12. The method of claim 9, wherein step (c) includes considering network traffic, a handover frequency, and a packet forwarding delay time to evaluate the level of satisfaction.

13. The method of claim 12, wherein step (c) includes performing setting or changing on each weighting factor of the network traffic, the handover frequency, and the packet forwarding delay time to evaluate the level of satisfaction.

14. The method of claim 13, wherein step (c) includes adjusting the weighting factor in consideration of a preference tendency of a user on a characteristic of an application and evaluating the level of satisfaction.

15. The method of claim 9, wherein step (b) includes determining the access node using handover policy update information that is a result of learning information about the evaluation on the level of satisfaction received from a plurality of user terminals.
